(19) United States
(12) Patent Application Publication
(10) Pub. No.: US 2013/0202309 A1
(43) Pub. Date: Aug. 8, 2013

(54) METHOD OF PERFORMING HANDOVER IN WIRELESS OPTICAL COMMUNICATION AND MOBILE STATION USING THE SAME

(71) Applicant: Electronics and Telecommunications Research Institute, Daejeon (KR)

(72) Inventors: Hyun Seo PARK, Daejeon (KR); Soo Chang KIM, Daejeon (KR); Sung-Min OH, Gyeonggi-do (KR); Pyeong Jung SONG, Daejeon (KR); Seung Chan BANG, Daejeon (KR)

(73) Assignee: Electronics and Telecommunications Research Institute, Daejeon (KR)

(21) Appl. No.: 13/682,300

(22) Filed: Nov. 20, 2012

(30) Foreign Application Priority Data
Feb. 3, 2012 (KR) 10-2012-0011463

(51) Int. Cl. H04W 36/00; H04B 10/11

(52) U.S. Cl. CPC H04W 36/00; H04B 10/11
USPC 398/128

(57) ABSTRACT

In a wireless optical communication system, while a mobile station including a wireless optical transmitting/receiving apparatus, i.e., an optical mobile station (OMS), is mounted in a moving object and moves, the mobile station performs handover from a previous optical base station (OBS) to a new OBS. Here, the mobile station may include at least one OMS, and when the mobile station includes two OMSs, soft handover is performed, and when the mobile station includes one OMS, hard handover is performed.

### CROSS-REFERENCE TO RELATED APPLICATION

This application claims priority to and the benefit of Korean Patent Application No. 10-2012-0011463 filed in the Korean Intellectual Property Office on Feb. 3, 2012, the entire contents of which are incorporated herein by reference.

### BACKGROUND OF THE INVENTION

(a) Field of the Invention

The present invention relates to a method of performing handover in a wireless optical communication system and a mobile station using the same.

(b) Description of the Related Art

When several users ride and move together in a moving object such as a high speed railway or a highway bus, the transmission speed of mobile communication using a radio frequency signal is remarkably deteriorated, and handover simultaneously occurs due to several users' terminals and thus signaling overhead may occur.

Wireless optical communication technology using an optical signal instead of a radio frequency signal has been developed, and research on applying mobile communication to a moving object using wireless optical communication has been performed. In a wireless optical communication system that transmits/receives light using the atmosphere as an optical transmission path, in a state of communicating with a terminal that is a moving object, when the terminal deviates from a service area, handover should be performed in order to maintain a communication state.

However, because handover should be performed in wireless optical communication using an optical signal instead of a radio frequency signal, a handover method in mobile communication using an existing radio frequency signal cannot be applied. Further, not much research on a method of performing handover by applying wireless optical communication to a moving object has been performed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of efficiently performing handover in a wireless optical communication system.

The present invention has been made in an effort to further provide a mobile station that performs handover using a handover method.

An exemplary embodiment of the present invention provides a method of performing handover in a wireless optical communication system, the method including: transmitting, by an access gateway (AG), a beacon driving signal to a second optical base station (OBS) and transmitting a handover command to a first optical mobile station (OMS), when handover is requested in a state in which the first OMS and a first OBS of a mobile station communicate; changing, by the AG, a path for transmitting downlink traffic from a first path that is formed between the first OMS and the first OBS to a second path that is formed between a second OMS and the second OBS, when a message for forming a communication link with the second OMS of the mobile station is received from the second OBS; and transmitting an acknowledgment message of the message that requests to form the communication link to the second OBS.

The method may further include: transferring, by the first OMS of the mobile station, the handover command to the second OMS; transmitting, by the second OMS, a message that requests to form a communication link to the second OBS; and transmitting, by the second OBS, a message that requests to form a communication link with the second OMS of the mobile station to the AG.

The method may further include: transmitting, by the AG, the acknowledgment message to the second OBS and transmitting a communication link cancellation message to the first OBS; and receiving, by the AG, an acknowledgment message of the communication link cancellation message from the first OBS.

Another embodiment of the present invention provides a method of performing handover in a wireless optical communication system, the method including: receiving, by a first OMS of a mobile station, a handover command, in a state in which the first OMS communicates with a first OBS; receiving, by a second OMS of the mobile station, a beacon optical signal from the second OBS according to the handover command; transmitting, by the second OMS, a message that requests to form a communication link to the second OBS; and changing, by the second OMS, a path for transmitting uplink traffic from a first path that is formed between the first OMS and the first OBS to a second path that is formed between the second OMS and the second OBS, when the second OMS receives a confirmation message of the message that requests to form a communication link from the second OBS.

The receiving of a handover command may include transferring, by the first OMS, a handover command to the second OMS.

The method may further include receiving, by the second OMS, the beacon optical signal and aligning a position while transmitting and receiving an optical signal to and from the second OBS.

The method may further include, after the changing of a path: receiving, by the first OMS, a communication link cancellation message from the first OBS; and transmitting, by the first OMS, a confirmation message of the communication link cancellation message to the first OBS and canceling the communication link.

The method may further include: transferring, by the first OBS, when the first OBS receives a communication link cancellation message with the first OMS from an AG, the communication link cancellation message to the first OMS; receiving, by the first OBS, the confirmation message of the communication link cancellation message from the first OMS; and transmitting, by the first OBS, the confirmation message of the communication link cancellation message to the AG.

Yet another embodiment of the present invention provides a method of performing handover in a wireless optical communication system, the method including: receiving, by an OMS of a mobile station, a handover command in a state in which the OMS communicates with a first OBS; terminating, by the OMS, communication with the first OBS according to the handover command and receiving a beacon optical signal from the second OBS; transmitting, by the OMS, a message that requests to form a communication link to the second OBS; and changing, by the OMS, a path for transmitting uplink traffic from a first path that is formed between the first OMS and the first OBS to a second path that is formed between the second OMS and the second OBS, when the OMS receives a confirmation message of the message that requests to form a communication link from the second OBS.

Yet another embodiment of the present invention provides a method of performing handover in a wireless optical communication system, the method including: aligning, by an OMS, which is an optical transmitting and receiving apparatus of a mobile station, having communicated with a first OBS, an optical system with a second OBS for handover; and transmitting, by the OMS, a message that requests to form a communication link to the second OBS and requesting handover, after alignment of the optical system is complete.

The method may further include: receiving, by the first OBS, a communication link cancellation message with the OMS from an AG; and transmitting, by the first OBS, a confirmation message of a communication link cancellation message to the AG regardless of reception of a message representing confirmation of communication link cancellation from the OMS.

Yet another embodiment of the present invention provides a mobile station that performs handover in a wireless optical communication system, the mobile station including: a first OMS that transmits and receives an optical signal to and from an OBS; and a second OMS that transmits and receives an optical signal to and from the OBS and that communicates with the first OMS according to an internal interface. In a state in which the first OMS communicates with the first OBS, when the first OMS receives a handover command, the second OMS forms a communication link with the second OBS by receiving a beacon optical signal from the second OBS and transmits and receives data to and from the second OBS.

The first OMS may transfer the received handover command to the second OMS and maintain a communication link with the first OBS. The first OMS may terminate communication with the first OBS, when the first OMS receives a communication link cancellation message from the first OBS.

The mobile station may further include: at least one wireless access point that provides a communication service to a plurality of user terminals; and a router that relays communication between the wireless access point and the first OMS or the second OMS.

### BRIEF DESCRIPTION OF THE DRAWINGS

FIG. 1 is a diagram illustrating a structure of a wireless optical communication system according to an exemplary embodiment of the present invention.

FIG. 2 is a flowchart illustrating a handover method according to a first exemplary embodiment of the present invention.

FIG. 3 is a flowchart illustrating a handover method according to a second exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

Hereinafter, a method of performing handover in a wireless optical communication system and a mobile station using the same according to an exemplary embodiment of the present invention will be described with reference to the drawings.

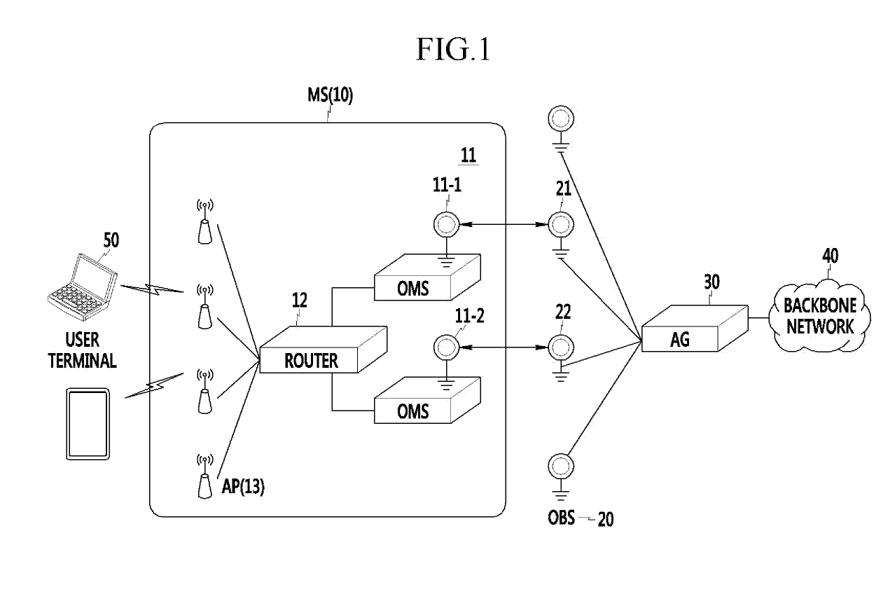

FIG. 1 is a diagram illustrating a structure of a wireless optical communication system according to an exemplary embodiment of the present invention.

In a wireless optical communication system that is shown in FIG. 1, a mobile station (MS) 10 receives a service by communicating with an optical base station (hereinafter referred to as an “OBS”) 20, and an OBS 20 is connected to a backbone network 40 through an access gateway (AG) 30.

The MS 10 provides a communication service for user terminals 50 by connecting with the OBS 20, is mounted in a moving object, and performs optical communication with the OBS 20. Here, a user terminal 50 may be a moving object itself, but indicates user equipment (UE) that connects to a wireless access point (AP) that a moving object provides. For example, the MS 10 may be mounted in a train, and the OBS 20 may be positioned at a periphery of a railway line of the train.

The MS 10 includes a wireless optical transmitting/receiving apparatus 11 that transmits/receives an optical signal to and from the OBS 20 and may further include a mobile router (MR) 12 and at least one wireless access point 13 (hereinafter referred to as a wireless AP). The wireless optical transmitting/receiving apparatus 11 is referred to as an optical mobile station (hereinafter referred to as an “OMS”).

The MS 10 according to an exemplary embodiment of the present invention includes at least one OMS 11. Here, the MS 10 includes two OMSs 11-1 and 11-2, but the present invention is not limited thereto.

The OMS 11 and the OBS 20 according to an exemplary embodiment of the present invention include a free space optical (FSO) communication apparatus (not shown) including an optical lens that focuses and outputs an optical signal and that focuses a received optical signal. A structure of such an FSO communication apparatus is well-known technology and thus a detailed description thereof will be omitted. For optical communication, a light direction from a transmitting terminal and a position of an element that detects light in a receiving terminal should be aligned, and when an output direction of light from a transmitting terminal does not correspond with a receiving terminal, a signal that is detected in the receiving terminal may become very weak and thus a process of aligning positions of the OMS 11 and OBS 20 is performed. In this case, the OMS 11 and the OBS 20 align a position through a process (pointing and tracking) of tracking a position in which an optical signal having a maximum output is transmitted/received while changing an angle of an optical lens of an FSO communication apparatus.

The wireless AP 13 may be installed at a plurality of positions within a moving object, for example, a train, and the user terminal 50 is connected to the wireless AP 13 and receives a communication service. The mobile router 12 enables communication to be performed between the wireless AP 13 and the OMS 11.

The OBS 20 provides a wireless communication service by performing optical communication with the MS 10, and provides a wireless communication service through optical communication to the MS 10 that is positioned in service coverage. The AG 30 manages the OBS 20 corresponding to a present position of the MS 10 and enables optical communication to be performed between the OBS 20 and the OMS 11 of the MS 10.

Because the MS 10 is mounted in a moving object, as the moving object moves, the connecting OBS 20 should be changed and thus handover for processing for this is requested. As the MS 10 moves, when handover occurs, the AG 30 switches a data traffic path to the MS 10 to a new OBS according to movement of the MS 10.

Hereinafter, a method of performing handover according to an exemplary embodiment of the present invention based on such a structure will be described.

When the MS 10 includes an OMS 11, the MS 10 performs hard-type handover that cuts off communication with a previous OBS and that starts communication with a new OBS. Alternatively, when the MS 10 includes two OMSs 11-1 and 11-2, the MS 10 performs soft handover that starts communication with a new OBS and then cuts off a connection to a previous OBS.

First, a method of performing handover according to a first exemplary embodiment of the present invention will be described. The first exemplary embodiment of the present invention relates to a method of performing handover when the MS 10 includes two OMSs 11-1 and 11-2.

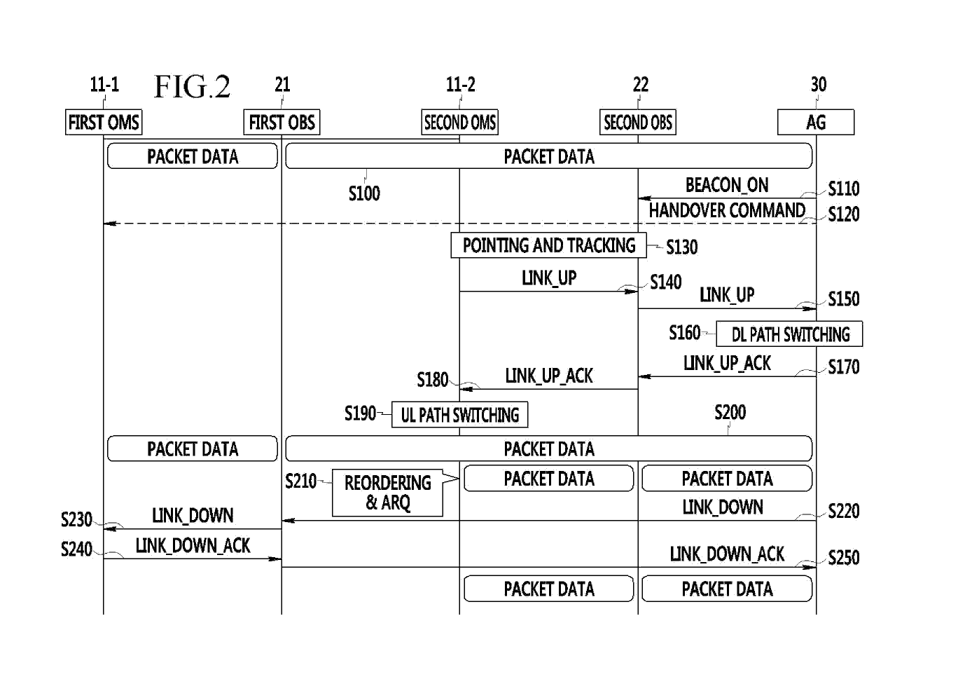

FIG. 2 is a flowchart illustrating a handover method according to a first exemplary embodiment of the present invention.

When the MS 10 performs optical communication with the first OBS 21 using the first OMS 11-1, which is one of two OMSs 11-1 and 11-2, and receives a packet data service (S100), the MS 10 that is mounded in a moving object moves according to movement of the moving object (e.g., train), and thus handover is requested.

When handover is requested, the AG 30 transmits a beacon driving signal Beacon_On to a new OBS, i.e., the second OBS 22 in a moving direction of the MS 10 (S110). The second OBS 22 starts communication with the MS 10 according to a beacon driving signal Beacon_On. For this purpose, the second OBS 22 aligns a position according to a preset initial alignment angle, i.e., the second OBS 20 opens a lens cover of an FSO communication apparatus (not shown), positions an angle of an optical lens at an initial alignment angle, and transmits a beacon optical signal Beacon_LED to the MS 10. The AG 30 transmits a handover command that instructs to perform handover to the MS 10. That is, the AG 30 transmits a handover command to the first OMS 11-1 of the MS 10 (S120).

In a state of performing communication with the first OBS 21, when the handover command is received, the first OMS 11-1 transfers the handover command to the second OMS 11-2 through an internal interface. Accordingly, the second OMS 11-2 prepares for communication with a new second OBS 22. For this purpose, the second OMS 11-2 aligns a position to a preset initial alignment angle, i.e., the second OMS 11-2 positions an angle of an optical lens (not shown) at an initial alignment angle and receives a beacon optical signal Beacon_LED that is transmitted from the second OBS 22. That is, the second OMS 11-2 and the second OBS 22 perform pointing and tracking for position alignment (S130). Accordingly, in order to transmit/receive an accurate optical signal, the second OMS 11-2 and the second OBS 22 are aligned at a position at which an output of the transmitted/received optical signal becomes a maximum. In this way, even in a state in which a position of the second OBS 22 which is a new OBS is aligned, a communication link with the first OBS 21 which is an existing OBS may be maintained through the first OMS 11-1 of the MS 10.

When optical pointing and tracking of the second OMS 11-2 and the second OBS 22 is complete, the second OMS 11-2 transmits a link request message LINK_UP for forming a communication link to the second OBS 22 (S140). The second OBS 22 transfers the link request message LINK_UP that is received from the second OMS 11-2 to the AG 30 (S150). Accordingly, the AG 30 performs downlink path switching and thus transmits downlink traffic that has been transmitted to an existing OBS, i.e., the first OBS 21, to a new OBS, i.e., the second OBS 22 (S160). That is, the AG 30 changes a path for transmitting downlink traffic from a first path that is formed between the first OMS 11-1 and the first OBS 21 to a second path that is formed between the second OMS 11-2 and the second OBS 22.

If path switching is complete, the AG 30 transmits an acknowledgment message LINK_UP_ACK of a link request to the second OBS 22 (S170), and the second OBS 22 transfers an acknowledgment message LINK_UP_ACK of the received link request to the second OMS 11-2 (S180).

When a link with the second OBS 22 is formed, by performing uplink path switching, the second OMS 11-2 transmits uplink traffic transmitting to the first OBS 21, which is an existing OBS, to the second OBS 22 through an existing OMS, i.e., the first OMS 11-1 (S190). Accordingly, uplink traffic of the MS 10 is transmitted to the second OBS 22, which is a new OBS, through the second OMS 11-2 (S200). Here, when a gap, particularly signal noise (SN), occurs due to a communication error or path switching between an OMS and an OBS, a reordering timer may be driven. When the reordering timer has expired, the second OMS 11-2 recovers a gap through re-transmission of an automatic repeat request (ARQ) (S210).

After transmitting an acknowledgment message LINK_UP_ACK of a link request to the new second OBS 22, in order to cancel a link between the existing first OBS 21 and the first OMS 11-1, the AG 30 transmits a link cancellation message LINK_DOWN to the first OBS 21, which is an existing OBS (S220). The first OBS 21 transfers the link cancellation message LINK_DOWN to the first OMS 11-1 (S230).

The first OMS 11-1, having received the link cancellation message LINK_DOWN, transmits a link cancellation acknowledgment message LINK_DOWN_ACK to the first OBS 21 (S240). Thereafter, the first OMS 11-1 terminates communication and thus aligns an angle of an optical lens to an initial angle. In this case, the FSO communication apparatus closes a lens cover and aligns an angle of an optical lens to an initial angle.

The first OBS 21 transfers the link cancellation acknowledgment message LINK_DOWN_ACK from the first OMS 11-1 to the AG 30 (S250). Thereafter, the first OBS 21 also aligns an angle of an optical lens to an initial angle.

Even in a case where the OMS 11 moves through the above-described process, a non-cutting communication service can be provided.

Hereinafter, a handover method according to a second exemplary embodiment of the present invention will be described. Here, a case where the MS 10 includes only an OMS will be exemplified. For better comprehension and ease of description, reference numeral “11” is provided to the OMS, and does not represent two OMSs that are shown in FIG. 1 but represents only an OMS. In some case, when the MS 10 includes an OMS, reference numeral “11” may indicate one of the OMSs 11-1 and 11-2.

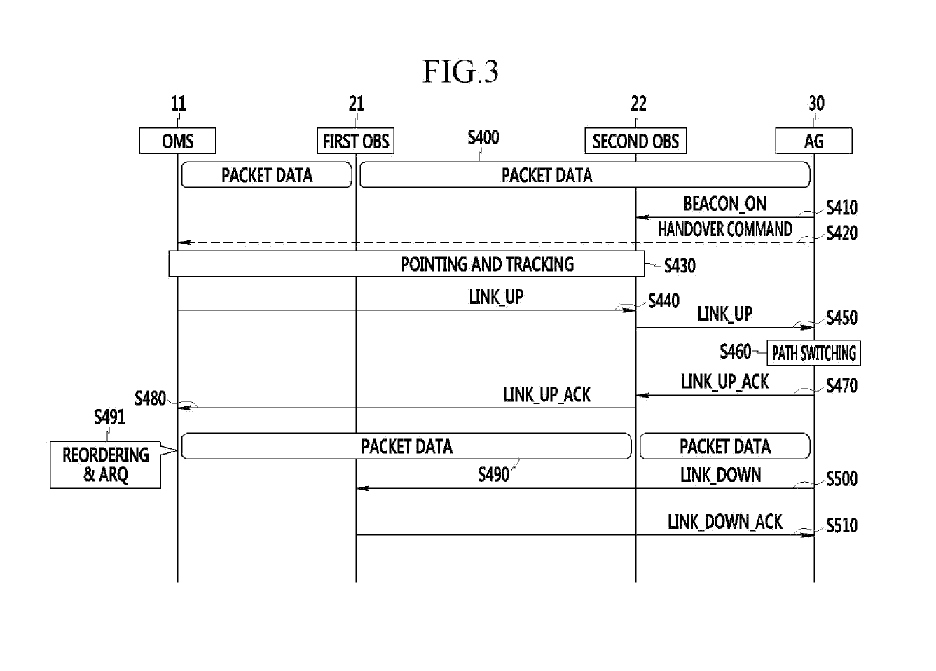

FIG. 3 is a flowchart illustrating a method of performing handover according to the second exemplary embodiment of the present invention.

In a state where the MS 10 receives a packet data service by performing optical communication with the first OBS 21 using the OMS 11 (S400), as the MS 10 that is mounted in a moving object moves according to movement of a moving object (e.g., train), when handover is requested, the AG 30 transmits a beacon driving signal Beacon_On to a new OBS, i.e., the second OBS 22, in a moving direction of the MS 10 (S410). Accordingly, the second OBS 22 positions an angle of an optical lens of an FSO communication apparatus (not shown) at an initial alignment angle and transmits a beacon optical signal Beacon_LED to the MS 10. The AG 30 transmits a handover command that instructs to perform handover to the MS 10 (S420).

In a state where the OMS 11 of the MS 10 communicates with the first OBS 21, when a handover command is received, the OMS 11 terminates communication with the first OBS 21, and the OMS 11 aligns a position to a preset initial alignment angle for communication with the new second OBS 22. That is, the OMS 11 positions an angle of an optical angle lens (not shown) at an initial alignment angle and receives a beacon optical signal Beacon_LED that is transmitted from the second OBS 22. The OMS 11 and the second OBS 22 perform pointing and tracking while performing position alignment (S430). Accordingly, the OMS 11 and the second OBS 22 are aligned to a position at which an optical signal receiving output that transmits/receives between the OMS 11 and the second OBS 22 becomes a maximum.

When optical pointing and tracking of the OMS 11 and the second OBS 22 is complete, the OMS 11 transmits a link request message LINK_UP for forming a communication link to the second OBS 22 (S440). The second OBS 22 transfers a link request message LINK_UP that is received from the OMS 11 to the AG 30 (S450), and thus by performing downlink path switching, the AG 30 transmits downlink traffic having been transmitted to an existing OBS, i.e., the first OBS 21, to a new OBS, i.e., the second OBS 22 (S460).

When path switching is complete, the AG 30 transmits a link request acknowledgment message LINK_UP_ACK to the second OBS 22 (S470), and the second OBS 22 transfers an acknowledgment message LINK_UP_ACK of the received link request to the OMS 11 (S480). Accordingly, a communication link is formed between the second OBS 22 and the OMS 11 and thus a packet is transmitted/received (S490). Even in a case where a gap occurs due to a communication error or path switching between the OMS and the OBS, the OMS 11 recovers a gap through ARQ re-transmission using a reordering timer, as in the first exemplary embodiment (S491).

The AG 30 transmits an acknowledgment message LINK_UP_ACK of the link request to the new second OBS 22, and transmits a link cancellation message LINK_DOWN to the first OBS 21, which is an existing OBS (S500). Because the first OBS 21 has already known that a communication link between the first OBS 21 and the OMS 11 is cut off, the first OBS 21 does not notify the OMS 11 of link cancellation and transmits a link cancellation acknowledgment message LINK_DOWN_ACK to the AG 30 (S510). Thereafter, the FSO communication apparatus of the first OMS 11-1 closes a lens cover and aligns an angle of an optical lens to an initial angle.

Even in a case where the MS 10 includes an OMS, handover can be efficiently performed through such a process.

Before the above-described soft handover is performed, a previous communication link may be cut off. However, even in such a case, according to the above-described handover method, because a command that instructs to perform handover like step S410 is previously received from a network, i.e., the AG 30, communication with a new OBS can be immediately started and thus a time in which a communication link is cut off can be considerably reduced.

According to an exemplary embodiment of the present invention, while positions of a base station and a mobile station are aligned in a wireless optical communication system, a communication link can be maintained, and particularly, even when the mobile station is mounted in a moving object such as a train, communication can be prevented from being cut off due to handover.

Further, as the mobile station is formed to include two wireless optical transmitting/receiving apparatuses, while maintaining an optical communication link with an existing base station, handover for optical communication with a new base station can be efficiently performed. Further, when it is difficult to perform soft handover, by performing hard handover, adaptive handover can be performed according to a case.

Further, before handover occurs, because a control message including a command that instructs to perform handover is received from a network, even when hard handover is performed, a time in which a communication link is cut off can be remarkably reduced.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of performing handover in a wireless optical communication system, the method comprising:
transmitting, by an access gateway (AG), a beacon driving signal to a second optical base station (OBS) and transmitting a handover command to a first optical mobile station (OMS), when handover is requested in a state in which the first OMS and a first OBS of a mobile station communicate;
changing, by the AG, a path for transmitting downlink traffic from a first path that is formed between the first OMS and the first OBS to a second path that is formed between a second OMS and the second OBS, when a message for forming a communication link with the second OMS of the mobile station is received from the second OBS; and
transmitting an acknowledgment message of the message that requests to form the communication link to the second OBS.

2. The method of claim 1, further comprising:
transferring, by the first OMS of the mobile station, the handover command to the second OMS;
transmitting, by the second OMS, a message that requests to form a communication link to the second OBS; and
transmitting, by the second OBS, a message that requests to form a communication link with the second OMS of the mobile station to the AG.

3. The method of claim 1, further comprising:
transmitting, by the AG, the acknowledgment message to the second OBS and transmitting a communication link cancellation message to the first OBS; and
receiving, by the AG, an acknowledgment message of the communication link cancellation message from the first OBS.

4. The method of claim 3, further comprising:
transmitting, by the first OBS, the communication link cancellation message to the first OMS;
receiving, by the first OBS, a cancellation message of the communication link cancellation message from the first OBS; and
transmitting, by the first OBS, the cancellation message of the communication link cancellation message to the AG.

5. A method of performing handover in a wireless optical communication system, the method comprising:
receiving, by a first OMS of a mobile station, a handover command, in a state in which the first OMS communicates with a first OBS;
receiving, by a second OMS of the mobile station, a beacon optical signal from a second OBS according to the handover command;
transmitting, by the second OMS, a message that requests to form a communication link to the second OBS; and
changing, by the second OMS, a path for transmitting uplink traffic from a first path that is formed between the first OMS and the first OBS to a second path that is formed between the second OMS and the second OBS, when the second OMS receives a confirmation message of the message that requests to form a communication link from the second OBS.

6. The method of claim 5, wherein the receiving of a handover command comprises transferring, by the first OMS, a handover command to the second OMS.

7. The method of claim 5, further comprising receiving, by the second OMS, the beacon optical signal and aligning a position while transmitting and receiving an optical signal to and from the second OBS.

8. The method of claim 5, further comprising, after the changing of a path:
receiving, by the first OMS, a communication link cancellation message from the first OBS; and
transmitting, by the first OMS, a confirmation message of the communication link cancellation message to the first OBS and canceling the communication link.

9. The method of claim 8, further comprising:
transferring, by the first OBS, when the first OBS receives a communication link cancellation message with the first OMS from an AG, the communication link cancellation message to the first OMS;
receiving, by the first OBS, the confirmation message of the communication link cancellation message from the first OMS; and
transmitting, by the first OBS, the confirmation message of the communication link cancellation message to the AG.

10. The method of claim 5, further comprising, after the changing of a path:
transmitting and receiving, by the second OMS, packet data to and from the second OBS through the second path; and
driving, by the second OMS, a reordering timer when a gap occurs due to a communication error or path switching and requesting re-transmission of a packet to the second OBS, when the reordering timer has elapsed.

11. A method of performing handover in a wireless optical communication system, the method comprising:
receiving, by an OMS of a mobile station, a handover command in a state in which the OMS communicates with a first OBS;
terminating, by the OMS, communication with the first OBS according to the handover command and receiving a beacon optical signal from the second OBS;
transmitting, by the OMS, a message that requests to form a communication link to the second OBS; and
changing, by the OMS, a path for transmitting uplink traffic from a first path that is formed between the first OMS and the first OBS to a second path that is formed between the second OMS and the second OBS, when the OMS receives a confirmation message of the message that requests to form a communication link from the second OBS.

12. The method of claim 11, further comprising receiving, by the OMS, the beacon optical signal and aligning a position while transmitting and receiving an optical signal to and from the second OBS.

13. A method of performing handover in a wireless optical communication system, the method comprising:
aligning, by an OMS, which is an optical transmitting and receiving apparatus of a mobile station, having communicated with a first OBS, an optical system with a second OBS for handover; and
transmitting, by the OMS, a message that requests to form a communication link to the second OBS and requesting handover, after alignment of the optical system is complete.

14. The method of claim 11, further comprising:
receiving, by the first OBS, a communication link cancellation message with the OMS from an AG; and
transmitting, by the first OBS, a confirmation message of a communication link cancellation message to the AG regardless of reception of a message representing confirmation of communication link cancellation from the OMS.

15. A mobile station comprising:
a first OMS that transmits and receives an optical signal to and from an OBS; and
a second OMS that transmits and receives an optical signal to and from the OBS and that communicates with the first OMS according to an internal interface,
wherein in a state in which the first OMS communicates with the first OBS, when the first OMS receives a handover command, the second OMS forms a communication link with the second OBS by receiving a beacon optical signal from the second OBS and transmits and receives data to and from the second OBS.

16. The mobile station of claim 15, wherein the first OMS transfers the received handover command to the second OMS and maintains a communication link with the first OBS.

17. The mobile station of claim 16, wherein the first OMS terminates communication with the first OBS, when the first OMS receives a communication link cancellation message from the first OBS.

18. The mobile station of claim 15, wherein the second OMS performs pointing and tracking of aligning a position while transmitting and receiving an optical signal to and from the second OBS, and when the second OMS receives an acknowledgment message for a communication link formation request from the second OBS, the second OMS changes a path for transmitting uplink traffic from a first path that is formed between the first OMS and the first OBS to a second path that is formed between the second OMS and the second OBS.

19. The mobile station of claim 15, further comprising:
at least one wireless access point that provides a communication service to a plurality of user terminals; and
a router that relays communication between the wireless access point and the first OMS or the second OMS.

20. The mobile station of claim 15, wherein the mobile station is mounted in a train, and the first and second OBSs are positioned at a periphery of a railway line of the train.
